(19) United States
(12) Patent Application Publication
(10) Pub. No.: US 2008/0092396 A1
(43) Pub. Date: Apr. 24, 2008

(54) Bow saw structure

(76) Inventor: Kuang-Pin Wang, Wurih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/583,014

(22) Filed: Oct. 19, 2006

(51) Int. Cl. B23D 45/00

(52) U.S. Cl. 30/166.3

(57) ABSTRACT

An improved bow saw structure includes a fixed base and a grip portion, and one side of the fixed base is coupled to the grip portion, and the fixed base and the grip portion are fixed by at least one fixing element, and more than one shock absorbing elements are installed between the fixed base and the grip portion, such that the shock absorbing elements between the fixed base and the grip portion produce a shock absorbing effect to reduce vibrations produced by the bow saw.

### BACKGROUND OF THE INVENTION

1. Field of the Invention

The present invention relates to an improved bow saw structure, and more particularly to a bow saw capable of absorbing vibrations at a grip portion when the bow saw is used for sawing a work piece.

2. Description of the Related Art

A bow saw is a common tool used for sawing, and a traditional bow saw as shown in FIG. 5 generally comes with a fixed body, so that when a user uses a bow saw of this type to saw a work piece, the vibrations produced by the bow saw cause discomfort and numbness to the user's hand, and the user cannot control the grip effectively and thus lowering the working efficiency. If the user does not pay much attention, the bow saw or the work piece may be damaged, or even the user may get injured. Therefore, the key point of the present invention is to overcome the foregoing shortcomings of the traditional bow saws.

### SUMMARY OF THE INVENTION

The primary objective of the present invention is to solve the aforementioned problems and provide an improved bow saw structure that can reduce discomfort or numbness caused by vibrations produced by a bow saw when the bow saw is used for sawing a work piece.

To achieve the foregoing objective, the invention provides an improved bow saw structure comprising a fixed base and a grip portion, and the fixed base is connected to the grip portion by at least one fixing element, and more than one shock absorbing elements are installed between the fixed base and the grip portion.

### BRIEF DESCRIPTION OF THE DRAWINGS

FIG. 1 is a perspective view of the present invention;

FIG. 2 is an exploded view of the present invention;

FIG. 3 is a schematic view of a first application status in accordance with the present invention;

FIG. 4 is a schematic view of a second application status in accordance with the present invention; and

FIG. 5 is a schematic structural view of a traditional bow saw.

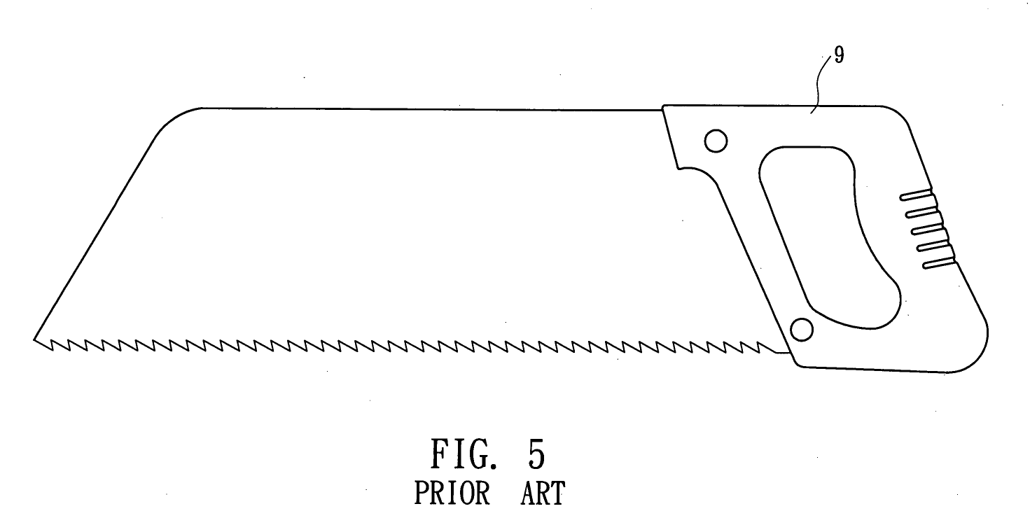

### DETAILED DESCRIPTION OF THE PREFERRED EMBODIMENTS

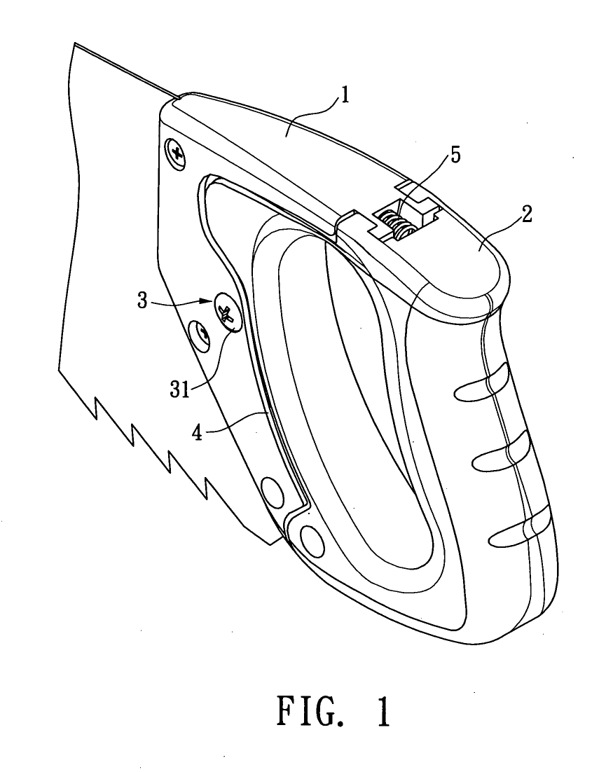

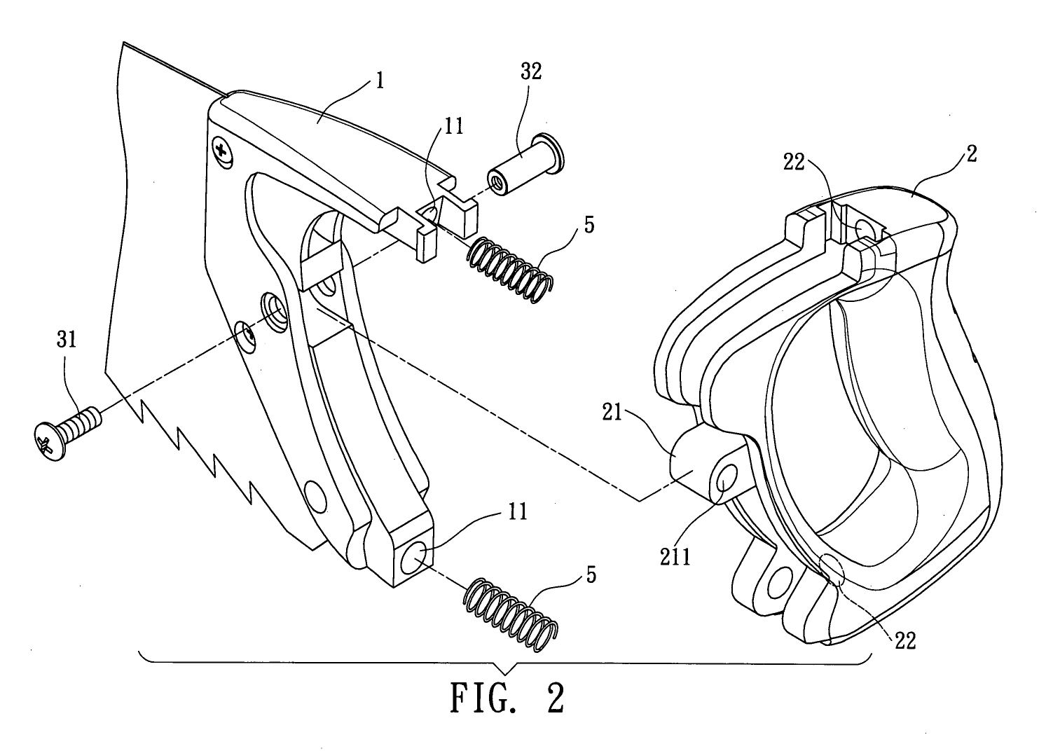

Referring to FIGS. 1 to 4 for an improved bow saw structure in accordance with preferred embodiments of the present invention, the structure comprises a fixed base 1 and a grip portion 2, and a side of the fixed base 1 is coupled to a joint portion 21 of the grip portion 2 by at least one fixing element 3, and the joint portion of this embodiment has a fixing hole 211, and the fixing elements 3 are provided for securing a male thread portion 31 and a female thread portion 32, and the fixed base 1 and the grip portion 2 are secured with each other by passing the fixed base 1 through a fixing hole 211 of the grip portion 2, and a shock absorbing space 4 is defined between the fixed base 1 and the grip portion 2 for allowing a slight rotation after the fixed base 1 and the grip portion 2 are fixed and positioned.

The fixed base 1 has a first groove 11 disposed separately on both top and bottom of the fixed base 1, and the grip portion 2 has a second groove 22 disposed separately on both top and bottom of the second groove 22, and a plurality of shock absorbing elements 5 are installed respectively in the first groove 11 and the second groove 22 on both top and bottom of the grip portion 2 corresponding to the fixed base 1, and the shock absorbing elements 5 of this embodiment are compression springs.

From the foregoing structure, the joint portion 21 of the grip portion 2 of the bow saw in accordance with the present invention is fixed to the fixed base 1, such that the joint portion 21 of the grip portion 2 becomes a fulcrum, and users can use the bow saw to operate with the shock absorbing space 4 formed after the fixed base 1 and the grip portion 2 to perform a sawing job, and the angle of gripping the grip portion 2 can have a slight change for driving the plurality of shock absorbing elements 5 between the fixed base 1 and the grip portion 2 to produce a shock absorbing effect and reduce the vibrations produced when the bow saw is used for sawing a work piece.

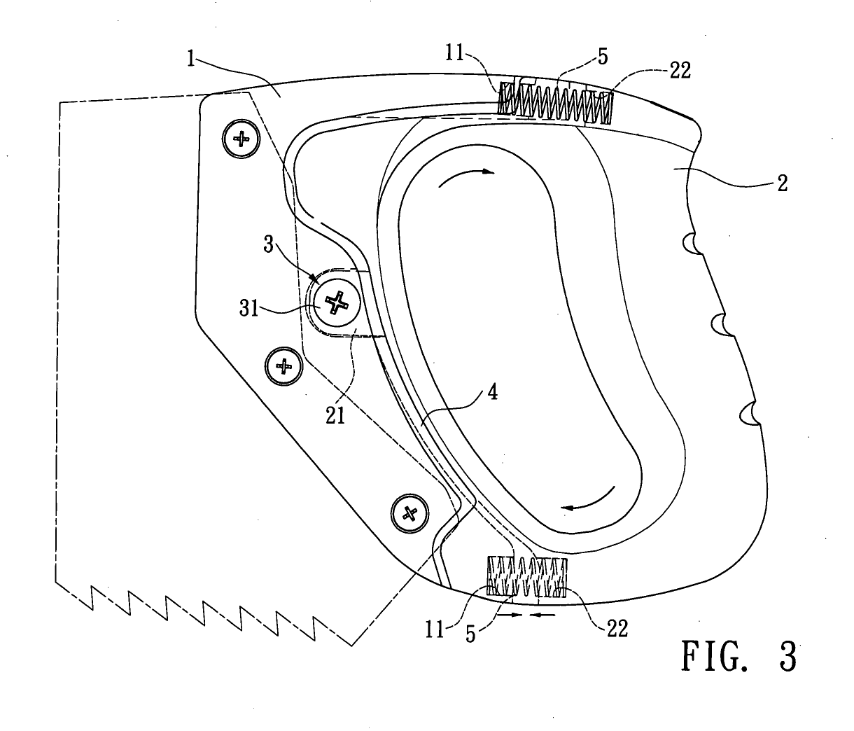

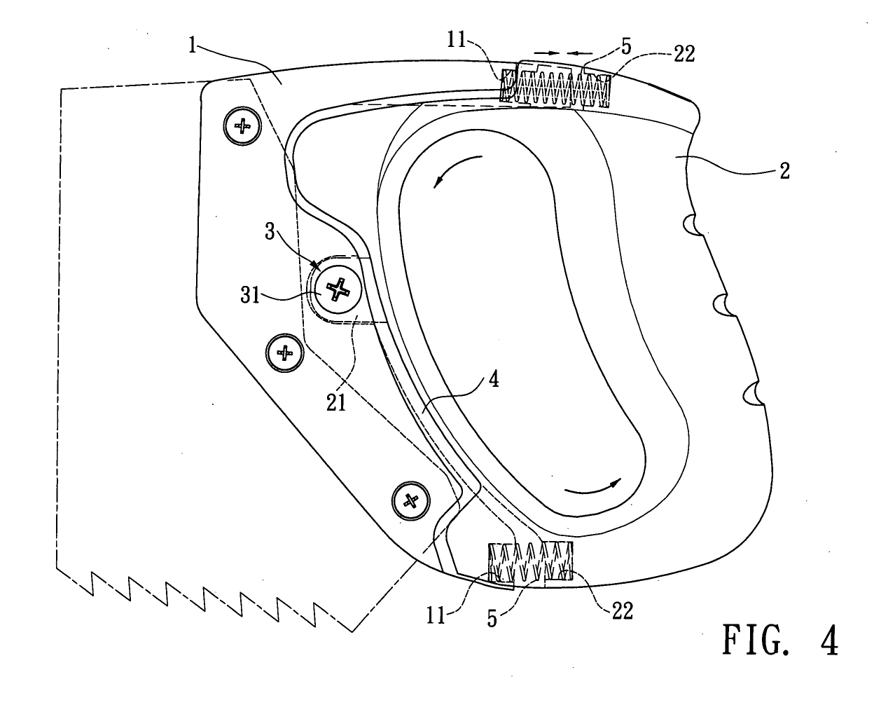

Referring to FIG. 3, the grip portion 2 is rotated counterclockwise for sawing a work piece, and the bottom of the shock absorbing elements 5 produces a shock absorbing effect to absorb vibrations produced by the bow saw. Referring to FIG. 4, the grip portion 2 is rotated clockwise to produce a shock absorbing effect at the top of the shock absorbing elements 5 to absorb vibrations produced by the bow saw.

In summation of the description above, the improved bow saw structure of the invention can reduce any discomfort or numbness to the user's hands when the user saws a work piece, and allow the user to securely hold the bow saw by a firm grip and improve the efficiency of sawing. The present invention also can prevent damages to the bow saw or the work piece caused by improper use.

What is claimed is:

1. An improved bow saw structure, comprising a fixed base and a grip portion, and said fixed base is coupled to said grip portion by at least one fixing element, and more than one shock absorbing elements are installed between said fixed base and said grip portion.

2. The improved bow saw structure of claim 1, wherein said fixed base includes a first groove disposed separately at both top and bottom on a side of said fixed base, and said grip portion includes two second grooves disposed on a side of said first groove that is coupled to said fixed base and corresponding to said each first groove of said fixed base, and two shock absorbing elements are installed respectively in said corresponding first groove and second groove between said fixed base and said grip portion.

3. The improved bow saw structure of claim 1, wherein said grip portion includes a joint portion with a fixing hole, and said fixing element is passed from said fixed base through a fixing hole of said grip portion for securing said fixed base and said grip portion, and a shock absorbing space is defined between said fixed base and said grip portion, and said fixing element is provided for securing a male thread portion and a female thread portion.

4. The improved bow saw structure of claim 1, wherein said shock absorbing elements are compression springs.
